(19) United States
(12) Patent Application Publication
(10) Pub. No.: US 2019/0005693 A1
(43) Pub. Date: Jan. 3, 2019

(54) PROGRAMMABLE DISPLAY DEVICE

(71) Applicant: Mitsubishi Electric Corporation, Chiyoda-ku (JP)

(72) Inventor: Hiroaki FUJIYAMA, Tokyo (JP)

(73) Assignee: Mitsubishi Electric Corporation, Chiyoda-ku (JP)

(21) Appl. No.: 16/069,193

(22) PCT Filed: Jun. 8, 2016
(86) PCT No.: PCT/JP2016/067130

§ 371 Date: Jul. 11, 2018

(51) Int. Cl. G06T 11/20; G05B 19/05; G08B 21/18

(52) U.S. Cl. CPC G06T 11/206; G05B 2219/13058; G08B 21/18; G05B 19/052

(57) ABSTRACT

A programmable display device includes a drive recorder information processing unit that obtains a specific set of data from a servo amplifier that holds drive recorder information including both a first set of data, being a plurality of items of data of a servomotor in which an alarm has occurred, and also being sequential data of before and after the occurrence of the alarm, and a second set of data, being data of all the items upon the occurrence of the alarm of the servomotor in which the alarm has occurred, the specific set of data being a third set of data indicating the alarm corresponding to the drive recorder information, and displays a first screen that displays a list of alarms; and a graphical waveform information processing unit that displays a second screen that displays a graphical representation of the first set of data.

### FIELD

The present invention relates to a programmable display device for displaying the state of a servo amplifier.

### BACKGROUND

A servo amplifier used in a factory automation system performs processing of multiple items of data pertaining to a servomotor driven by that servo amplifier during an operation of driving the servomotor. Such a servo amplifier may be capable of holding, upon an occurrence of an alarm, graphical waveform data covering a certain time period including the occurrence of the alarm relating to the servomotor in which the alarm has occurred, and information-upon-alarm-occurrence listing data containing ail the items upon the occurrence of the alarm relating to the servomotor in which the alarm has occurred, together with an alarm number. The capability of holding graphical waveform data and information-upon-alarm-occurrence listing data together with an alarm number is hereinafter referred to as “drive recorder function.” Note that the term “factory automation system” is usually abbreviated as “FA system,” and thus the term “FA system” will be used hereinafter. In addition, since an anomaly is generally referred to as “alarm” in the field of FA systems, an anomaly is also referred to herein as “alarm.” Thus, the term “alarm analysis” as used herein means analysis of the cause of an anomaly.

Conventionally, each time an anomaly occurs in a servo amplifier and/or in a servomotor in an FA system, it has been necessary for an end user to bring a personal computer to the site, execute a software program dedicated to the servo amplifier on the personal computer, read drive recorder information held in the servo amplifier by the drive recorder function using a dedicated software, and display a graphical representation of the drive recorder information, and/or perform another similar operation to investigate the cause of the anomaly. A feature of a programmable display device that reads and displays drive recorder information stored in a servo amplifier is hereinafter referred to as “drive recorder information presentation function.”

As disclosed in Patent Literature 1, obtaining data from a servo amplifier requires a computer that includes a dedicated software program installed therein. However, a computer including a dedicated software program installed therein may not always be available at the production site, thereby sometimes requiring time to prepare a personal computer, and thus taking time to restore the system.

As disclosed in Patent Literature 2, a programmable display device connected to a servo amplifier can obtain current value data of the servo amplifier. Therefore, routinely obtaining the data will enable such data to be obtained before and after the occurrence of an alarm.

### CITATION LIST

### Patent Literature

Patent Literature 1: Japanese Patent Application Laid-open No. 2004-295816

Patent Literature 2: Japanese Patent Application Laid-open No. 11-327610

### SUMMARY

### Technical Problem

However, the sampling period of the device required for alarm analysis is typically shorter than the sampling period of the programmable display device to obtain data from the device to be analyzed. Thus, such shorter sampling period will not achieve the performance required for investigating the cause of an alarm only by routinely obtaining the data using the programmable display device.

The present invention has been made in view of the foregoing, and it is an object of the present invention to provide a programmable display device capable of performing alarm analysis of a servo amplifier without needing a personal computer at the site where the FA system is installed.

### Solution to Problem

To solve the problem and to achieve the object described above, a programmable display device of the present invention includes a drive recorder information processing unit to obtain a specific set of data from a servo amplifier that holds drive recorder information including both a first set of data, being a plurality of items of data of a servomotor in which an alarm has occurred, and also being sequential data of before and after the occurrence of the alarm, and a second set of data, being data of all the items upon the occurrence of the alarm of the servomotor in which the alarm has occurred, the specific set of data being a third set of data indicating the alarm corresponding to the drive recorder information held in the servo amplifier, and to display a first screen that displays a list of the alarms whose drive recorder information is held in the servo amplifier. The programmable display device of the present invention also includes a graphical waveform information processing unit to obtain the first set of data from the servo amplifier, and to display a second screen that displays a graphical representation of the first set of data.

### Advantageous Effects of Invention

A programmable display device according to the present invention is advantageous in being capable of performing alarm analysis of a servo amplifier without needing a personal computer at the site where the FA system is installed.

### BRIEF DESCRIPTION OF DRAWINGS

FIG. 1 is a diagram illustrating a configuration of an FA system using a programmable display device according to a first embodiment of the present invention.

FIG. 2 is a functional block diagram of the programmable display device according to the first embodiment.

FIG. 3 is a flowchart illustrating an operational flow of the programmable display device according to the first embodiment.

FIG. 4 is a flowchart illustrating an operational flow of the programmable display device according to the first embodiment.

FIG. 5 is a flowchart illustrating an operational flow of the programmable display device according to the first embodiment.

FIG. 6 is a diagram illustrating an example of drive recorder information list screen displayed in the programmable display device according to the first embodiment.

FIG. 7 is a diagram illustrating an example of graphical waveform display screen of the programmable display device according to the first embodiment.

FIG. 8 is a diagram illustrating an example of information-upon-alarm-occurrence list screen of the programmable display device according to the first embodiment.

FIG. 9 is a conceptual diagram of data obtained, from a servo amplifier, by the programmable display device according to the first embodiment.

FIG. 10 is a functional block diagram of a programmable display device according to a second embodiment of the present invention.

FIG. 11 is a diagram illustrating a hardware configuration of the programmable display devices according to the first and second embodiments.

### DESCRIPTION OF EMBODIMENTS

Programmable display devices according to embodiments of the present invention will be described below in detail with reference to the drawings. Note that these embodiments are not intended to limit this invention.

### First Embodiment

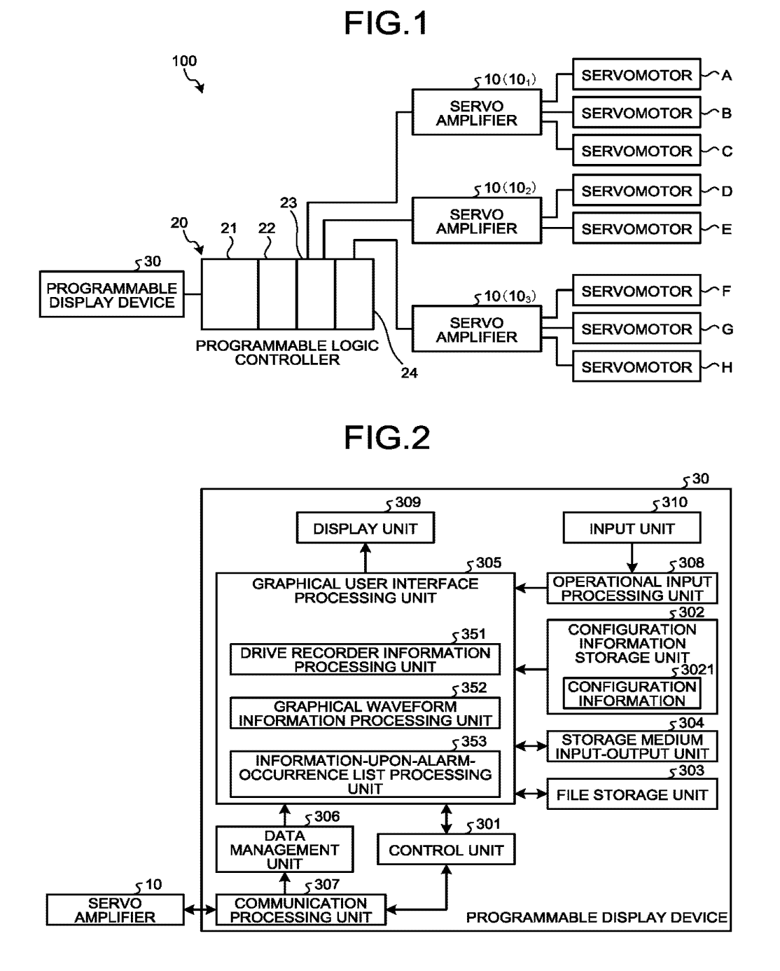

FIG. 1 is a diagram illustrating a configuration of an FA system using a programmable display device according to a first embodiment of the present invention. An FA system 100 includes a servo amplifier 10₁ that drives a servomotor A, a servomotor B, and a servomotor C; a servo amplifier 10₂ that drives a servomotor D and a servomotor E; a servo amplifier 10₃ that drives a servomotor F, a servomotor G, and a servomotor H; a programmable logic controller 20 that executes a sequence program to control the servo amplifiers 10₁, 10₂, and 10₃; and a programmable display device 30 that displays current value data of the servo amplifiers 10₁, 10₂, and 10₃. The servo amplifiers 10₁, 10₂, and 10₃ each have a drive recorder function to hold drive recorder information upon an occurrence of an alarm. Features common to the servo amplifiers 10₁, 10₂, and 10₃ will be described below. In the description below, the servo amplifiers 10₁, 10₂, and 10₃ are commonly referred to as “servo amplifier 10” when no differentiation is necessary. The programmable logic controller 20 is constituted by a combination of multiple programmable logic controller units 21, 22, 23, and 24. The servo amplifiers 10₁ and 10₂ are connected to the programmable logic controller unit 23, and the servo amplifier 10₃ is connected to the programmable logic controller unit 24. Note that the programmable display device 30 may be directly connected to a servo amplifier 10.

FIG. 2 is a functional block diagram of the programmable display device according to the first embodiment. The programmable display device 30 includes a control unit 301 that provides overall control; a configuration information storage unit 302 that stores configuration information 3021; a file storage unit 303 that stores the data obtained from the servo amplifiers 10 as a file; a storage medium input-output unit 304 that receives and outputs information from and to a detachable storage medium; a graphical user interface processing unit 305 that performs processing related to an operation, communication, and displaying based on the configuration information 3021, which is user configuration data for operating the programmable display device 30; and a data management unit 306 that temporarily stores the data obtained from the servo amplifiers 10. The programmable display device 30 also includes a communication processing unit 307 that communicates with an external device to read and write information from the servo amplifiers 10; an operational input processing unit 300 that receives an input operation, and transfers that information to the graphical user interface processing unit 305; a display unit 309 that displays information; and an input unit 310 that serves as an input interface. Examples of the detachable storage medium from and to which the storage medium input-output unit 304 reads and writes information include a Secure Digital (SD) memory card and a universal serial bus (USB) flash drive, but the detachable storage medium is not limited to an SD memory card or a USB memory.

The graphical user interface processing unit 305 includes a drive recorder information processing unit 351 that causes the display unit 309 to display the drive recorder information obtained from the data management unit 306; a graphical waveform information processing unit 352 that causes the display unit 309 to display a graphical representation of graphical waveform data; and an information-upon-alarm-occurrence list processing unit 353 that tabulates information-upon-alarm-occurrence listing data, and causes the display unit 309 to display the table generated. The drive recorder information processing unit 351 also monitors a trigger condition for collecting selected log data, obtains a device value of the external device from the communication processing unit 307, and collects the log data.

Upon an occurrence of an alarm, the corresponding servo amplifier 10 stores the graphical waveform data and the information-upon-alarm-occurrence listing data together with an alarm number, as the drive recorder information. The graphical waveform data is a plurality of items of data of the servomotor in which the alarm has occurred, and is sequential data of before and after the occurrence of the alarm. The graphical waveform data is also herein referred to as a first set of data. The information-upon-alarm-occurrence listing data is data of all the items upon the occurrence of the alarm relating to the servomotor in which the alarm has occurred. The information-upon-alarm-occurrence listing data is also herein referred to as a second set of data. The graphical waveform data is data of before and after the occurrence of the alarm. If multiple alarms have occurred in a servo amplifier 10, the drive recorder information is stored for each of the alarms.

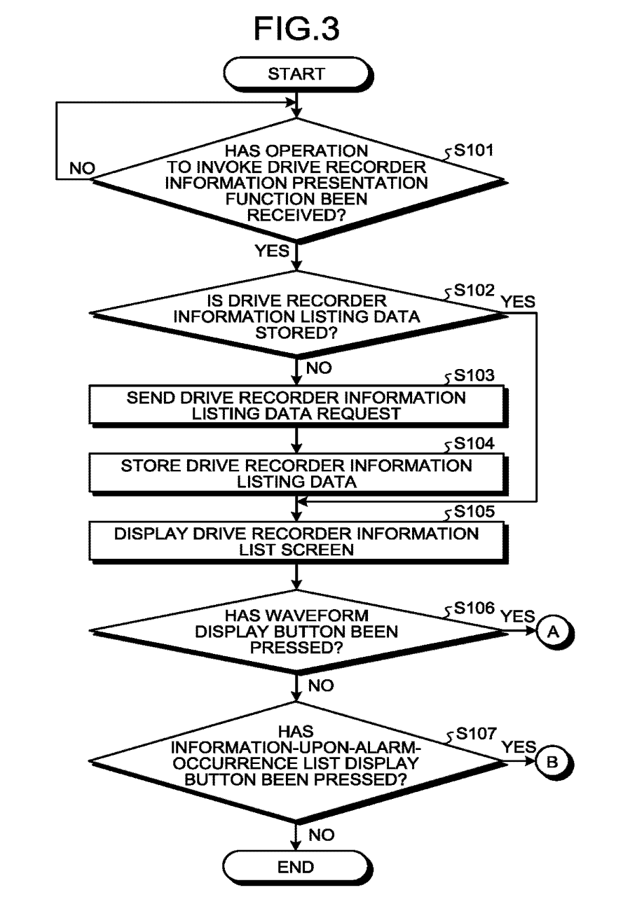

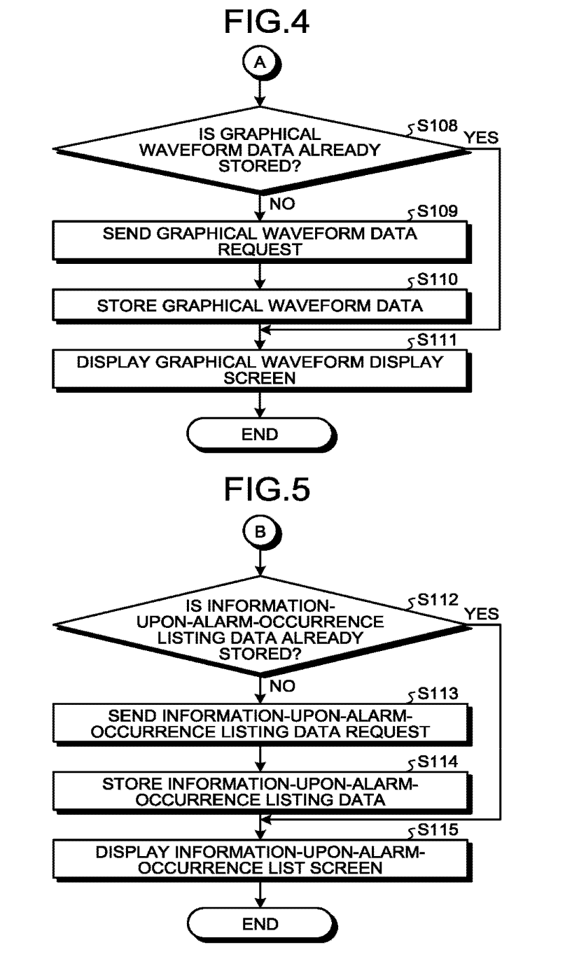

FIGS. 3 to 5 are each a flowchart illustrating an operational flow of the programmable display device according to the first embodiment. At step S101, the drive recorder information processing unit 351 determines whether an operation to invoke the drive recorder information presentation function has been performed. If no operation has been performed to invoke the drive recorder information presentation function, the result of the determination at step S101 is NO, and step S101 is thus repeated. If an operation to invoke the drive recorder information presentation function has been performed, the result of the determination at step S101 is YES, and the process then proceeds to step S102.

A first operational option to invoke the drive recorder information presentation function is to specify one of the servo amplifiers 10 of the FA system 100 using the programmable logic controller 20 and a path of the programmable logic controller unit 21, 22, 23, or 24. That is, the first operational option is to specify one of the servo amplifiers 10 connected to one of the programmable logic controller units 21, 22, 23, and 24 of the programmable logic controller 20.

A second operational option to invoke the drive recorder information presentation function is to press a start switch for invoking the drive recorder information presentation function. The start switch is a switch associated with one of the servo amplifiers 10 of the FA system 100. If the start switch is associated with none of the servo amplifiers 10, and the switch is pressed, the drive recorder information processing unit 351 causes the display unit 309 to display a screen that requests to specify one of the servo amplifiers 10.

A third operational option to invoke the drive recorder information presentation function is to associate the types of alarm with the servo amplifiers 10, and to specify an alarm type in an alarm list screen.

Performing one of the first, second, and third operational options described above causes the drive recorder information processing unit 351 to determine that an operation to invoke the drive recorder information presentation function has been performed.

At step S102, the drive recorder information processing unit 351 checks whether drive recorder information listing data of the servo amplifier 10 whose information is to be displayed is stored in the data management unit 306. The drive recorder information listing data as used herein is a third set of data indicating the alarm corresponding to the drive recorder information held in the servo amplifier 10. The phrase “servo amplifier 10 whose information is to be displayed” herein refers to the servo amplifier 10 specified using the path in the case of the first operational option, the servo amplifier 10 associated with the start switch in the case of the second operational option, or the servo amplifier 10 associated with an alarm type specified in the alarm list screen in the case of the third operational option. If drive recorder information listing data of the servo amplifier 10 whose information is to be displayed is stored in the data management unit 306, the result of the determination at step S102 is YES, and the process then proceeds to step S105. Otherwise, if drive recorder information listing data of the servo amplifier 10 whose information is to be displayed is not stored in the data management unit 306, the result of the determination at step S102 is NO, and the process then proceeds to step S103.

At step S103, the drive recorder information processing unit 351 sends a drive recorder information listing data request to the servo amplifier 10 whose information is to he displayed through the control unit 301 and the communication processing unit 307.

At step S104, the communication processing unit 307 receives the drive recorder information listing data in response to the drive recorder information listing data request, and stores the drive recorder information listing data received, in the data management unit 306. At step S105, the drive recorder information processing unit 351 reads the drive recorder information listing data stored in the data management unit 306, and causes the display unit 309 to display a drive recorder information list screen, which is a first screen, that displays a list of alarms whose drive recorder information is held in that servo amplifier 10.

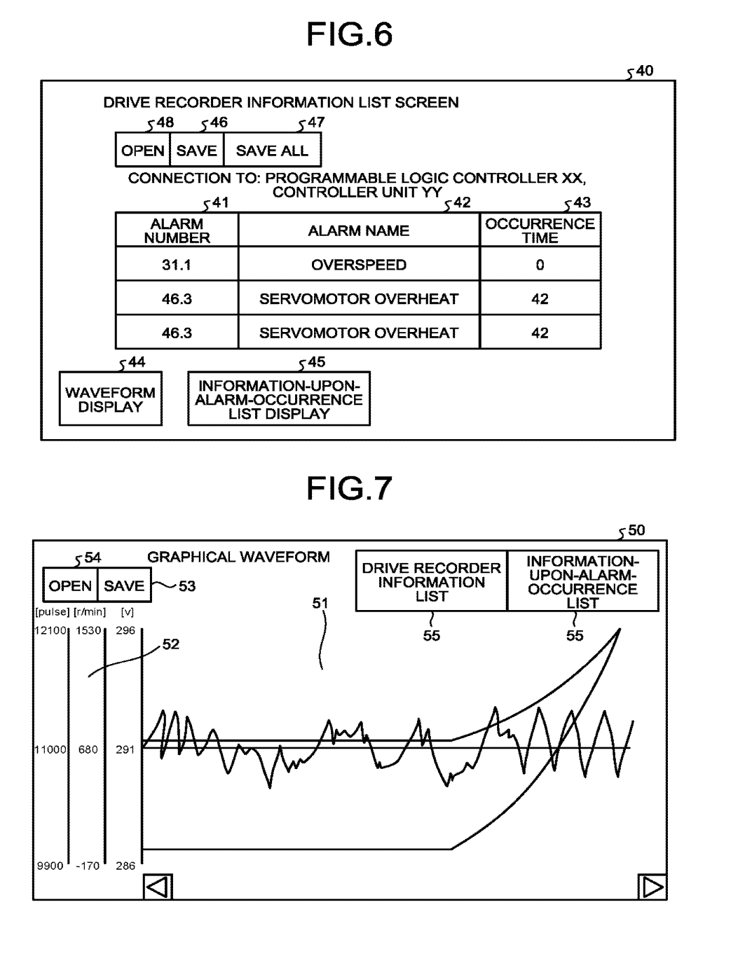

FIG. 6 is a diagram illustrating an example of drive recorder information list screen displayed in the programmable display device according to the first embodiment. A drive recorder information list screen 40 displays an alarm number 41, an alarm name 42, and an occurrence time 43. The drive recorder information list screen 40 includes a waveform display button 44 and an information-upon-alarm-occurrence list display button 45.

At step S106, the graphical waveform information processing unit 352 determines whether the waveform display button has been pressed under a condition in which any information of the drive recorder information is selected on the drive recorder information list screen. If the waveform display button has been pressed, the result of the determination at step S106 is YES, and the process then proceeds to step S108. Otherwise, if the waveform display button has not been pressed, the result of the determination at step S106 is NO, and the process then proceeds to step S107.

At step S107, the information-upon-alarm-occurrence list processing unit 353 determines whether the information-upon-alarm-occurrence list display button has been pressed under a condition in which any information of the drive recorder information is selected on the drive recorder information list screen. If the information-upon-alarm-occurrence list display button has been pressed, the result of the determination at step S107 is YES, and the process then proceeds to step S112. Otherwise, if the information-upon-alarm-occurrence list display button has not been pressed, the result of the determination at step S107 is NO, and then the process terminates.

As illustrated in FIG. 6, the drive recorder information list screen 40 includes a save button 46 and a save all button 47. A press of the save all button 47 in the drive recorder information list screen 40 causes the graphical user interface processing unit 305 to store the graphical waveform data and the information-upon-alarm-occurrence listing data of the servo amplifier 10 whose information is being displayed on the drive recorder information list screen 40 in the file storage unit 303 or in the storage medium connected to the storage medium input-output unit 304 as a file having a user-specified format. A press of the save button 46 in the drive recorder information list screen 40 under a condition in which an alarm is selected causes the graphical user interface processing unit 305 to store the graphical waveform data and the information-upon-alarm-occurrence listing data corresponding to the selected alarm in the file storage unit 303 or in the storage medium connected to the storage medium input-output unit 304 as a file having a user-specified format. The drive recorder information list screen 40 further includes an open button 48. A press of the open button 48 under a condition in which an alarm is selected causes the graphical user interface processing unit 305 to read the graphical waveform data and the information-upon-alarm-occurrence listing data corresponding to the selected alarm from the file storage unit 303 or from the storage medium connected to the storage medium input-output unit 304.

At step S108, the graphical waveform information processing unit 352 checks whether the graphical waveform data to be displayed is stored in the data management unit 306. If the graphical waveform data to be displayed is stored in the data management unit 306, the result of the determination at step S108 is YES, and the process then proceeds to step S111. Otherwise, if the graphical waveform data to be displayed is not stored in the data management unit 306, the result of the determination at step S108 is NO, and the process then proceeds to step S109.

At step S109, the graphical waveform information processing unit 352 sends a graphical waveform data request to the servo amplifier 10 whose information is to be displayed through the control unit 301 and the communication processing unit 307.

At step S110, the communication processing unit 307 receives the graphical waveform data in response to the graphical waveform data request, and stores the graphical waveform data received, in the data management unit 306. At step S111, the graphical waveform information processing unit 352 reads the graphical waveform data stored in the data management unit 306, and causes the display unit 309 to display a graphical waveform display screen, which is a second screen, that displays a graphical representation of the graphical waveform data. After completion of step S111, the process terminates.

FIG. 7 is a diagram illustrating an example of graphical waveform display screen of the programmable display device according to the first embodiment. A graphical waveform display screen 50 includes a waveform display region 51 and a vertical axis display region 52. The scales along the vertical axis displayed in the vertical axis display region 52 can be switched between a displayed state and a hidden state. Hiding at least a part of the scales along the vertical axis increases the area of the waveform display region 51.

The waveform display region 51 has a zoom function to enlarge a part of the graphical waveform. The zoom function is performed by a swipe operation to select the area to he enlarged, and then by tapping the area. If the horizontal to vertical ratio of the swipe operation does not match the horizontal to vertical ratio of the display area of the display unit 309, the graphical waveform information processing unit 352 enlarges the graphical waveform based on either the vertical component or the horizontal component of the swipe operation.

As illustrated in FIG. 7, the graphical waveform display screen 50 includes a save button 53 and an open button 54. A press of the save button 53 in the graphical waveform display screen 50 causes the graphical user interface processing unit 305 to store the graphical waveform data in the file storage unit 303 or in the storage medium connected to the storage medium input-output unit 304 as a file having a user-specified format. A press of the open button 54 in the graphical waveform display screen 50 causes the graphical user interface processing unit 305 to read the file of the graphical waveform data stored in the file storage unit 303 or in the storage medium connected to the storage medium input-output unit 304 to display a graphical waveform in the waveform display region 51.

At step S112, the information-upon-alarm-occurrence list processing unit 353 checks whether the information-upon-alarm-occurrence listing data to be displayed is stored in the data management unit 306. If the information-upon-alarm-occurrence listing data to be displayed is stored in the data management unit 306, the result of the determination at step S112 is YES, and the process then proceeds to step S115. Otherwise, if the information-upon-alarm-occurrence listing data is not stored in the data management unit 306, the result of the determination at step S112 is NO, and the process then proceeds to step S113.

At step S113, the information-upon-alarm-occurrence list processing unit 353 sends an information-upon-alarm-occurrence listing data request to the servo amplifier 10 whose information is to be displayed through the control unit 301 and the communication processing unit 307.

At step S114, the communication processing unit 307 receives the information-upon-alarm-occurrence listing data in response to the information-upon-alarm-occurrence listing data request, and stores the information-upon-alarm-occurrence listing data received, in the data management unit 306. At step S115, the information-upon-alarm-occurrence list processing unit 353 reads the information-upon-alarm-occurrence listing data stored in the data management unit 306, and causes the display unit 309 to display an information-upon-alarm-occurrence list screen, which is a third screen, that lists items of data included in the information-upon-alarm-occurrence listing data. After completion of step S115, the process terminates.

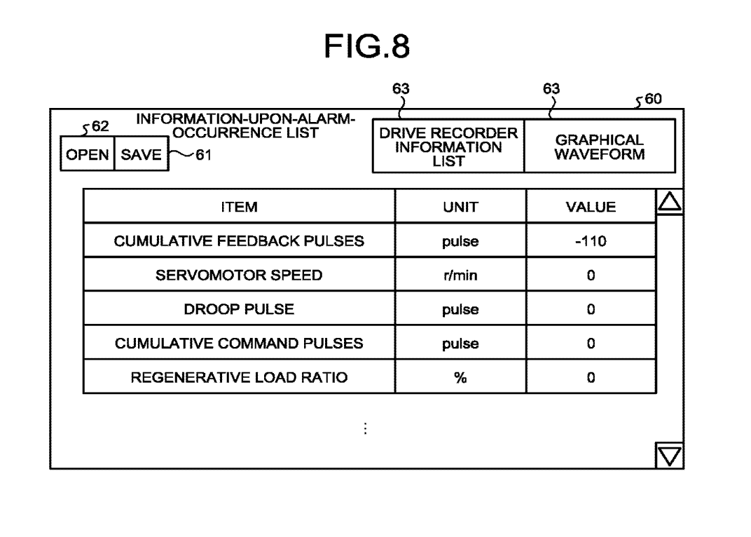

FIG. 8 is a diagram illustrating an example of information-upon-alarm-occurrence list screen of the programmable display device according to the first embodiment. An information-upon-alarm-occurrence list screen 60 lists the values at the time of the occurrence of the alarm, of the data stored in the servo amplifier 10 whose information is to be displayed.

As illustrated in FIG. 8, the information-upon-alarm-occurrence list screen 60 includes a save button 61 and an open button 62. A press of the save button 61 in the information-upon-alarm-occurrence list screen 60 causes the graphical user interface processing unit 305 to store the information-upon-alarm-occurrence listing data in the file storage unit 303 or in the storage medium connected to the storage medium input-output unit 304 as a file having a user-specified format. A press of the open button 62 in the information-upon-alarm-occurrence list screen 60 causes the graphical user interface processing unit 305 to read the file of the information-upon-alarm-occurrence listing data stored in the file storage unit 303 or in the storage medium connected to the storage medium input-output unit 304 to display the information-upon-alarm-occurrence listing data.

As illustrated in FIGS. 7 and 8, the graphical waveform display screen 50 and the information-upon-alarm-occurrence list screen 60 include screen transition switches 55 and 63, respectively. A press of one of the screen transition switches 55 and 63 causes the graphical waveform display screen 50, the information-upon-alarm-occurrence list screen 60, or the drive recorder information list screen 40 to be switched to another.

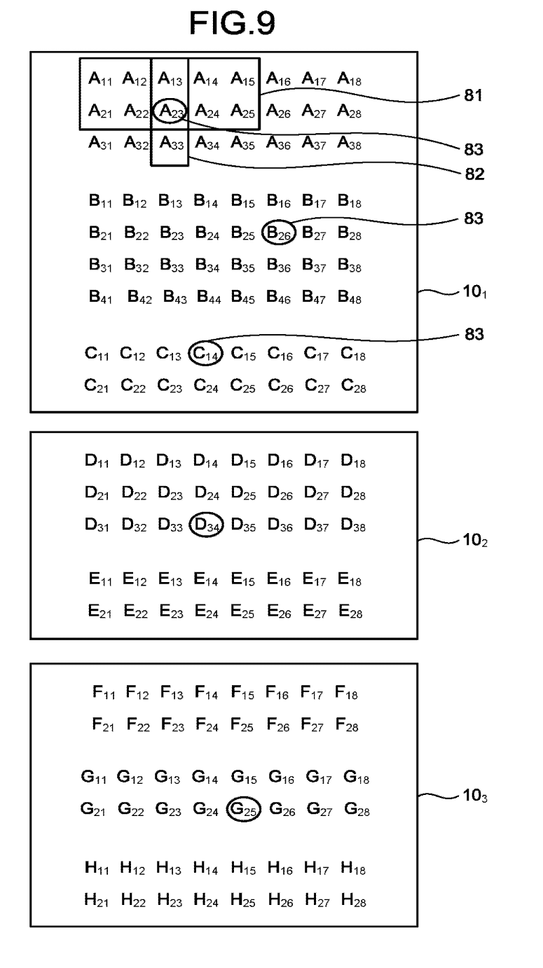

FIG. 9 is a conceptual diagram of data obtained, from a servo amplifier, by the programmable display device according to the first embodiment. Examples of the data obtained by the programmable display device 30 from the servo amplifiers 10 include the rotational speed and the temperature of each of the servomotors, but the obtained data is not limited to the rotational speed and the temperature. The servo amplifier 10₁ holds data A₁₁ to A₃₈, which are data of the servomotor A, data B₁₁ to B₄₈, which are data of the servomotor B, and data C₁₁ to C₂₈, which are data of the servomotor C. The servo amplifier 10₂ holds data D₁₁ to D₃₈, which are data of the servomotor D, and data E₁₁ to E₂₈, which are data of the servomotor E. The servo amplifier 10₃ holds data F₁₁ to F₂₈, which are data of the servomotor F, data G₁₁ to G₂₈, which are data of the servomotor G, and data H₁₁ to H₂₈, which are data of the servomotor H. As used herein, the notation “data A₁₁” represents a piece of data that comes temporally first among the number 1 data of the servomotor A. This also means that the number 1 data of the servomotor A has changed sequentially as A₁₁, A₁₂, A₁₃, A₁₄, A₁₅, A₁₆, A₁₇, and A₁₈. A similar notation applies to the other data.

Data A₂₃, B₂₆, C₁₄, D₃₄, and G₂₅ circled in FIG. 9 are data having an alarm. If data of the servo amplifier 10₁ is to be displayed, drive recorder information listing data 83 includes data A₂₃, B₂₆, and C₁₄. Using data A₂₃ having an alarm as an example, the drive recorder information for data A₂₃ includes, together with the alarm number, graphical waveform data 81 including data A₁₁, A₁₂, A₁₃, A₁₄, A₁₅, A₂₁, A₂₂, A₂₃, A₂₄, and A₂₅, and information-upon-alarm-occurrence listing data 82 including data A₁₃, A₂₃, and A₃₃. Note that data A₃₁, A₃₂, A₃₃, A₃₄, and A₃₅ are essentially not for display in the graph display, and are thus not included in the graphical waveform data 81.

The foregoing description has assumed that the graphical waveform data 81 is data of the servomotor A in which an alarm has occurred. However, the graphical waveform data 81 may also include data relating to other servomotors B and C in addition to the data of the servomotor A. For example, the graphical waveform data 81 may include data C₁₁, C₁₂, C₁₃, C₁₄, C₁₅, C₂₁, C₂₂, C₂₃, C₂₄, and C₂₅ in addition to data A₁₁, A₁₂, A¹³, A₁₄, A₁₅, A₂₁, A₂₂, A₂₃, A₂₄, A₂₅, A₃₁, A₃₂, A₃₃, A₃₄, and A₃₅. By obtaining data also from a servomotor different from the servomotor in which the alarm has occurred, a graphical waveform of data of a servomotor in which no alarm has occurred can also be displayed.

In addition, the foregoing description has assumed that the information-upon-alarm-occurrence listing data 82 is the data of the servomotor A in which an alarm has occurred upon the occurrence of the alarm. However, the information-upon-alarm-occurrence listing data 82 may also include data relating to other servomotors B and C upon the occurrence of the alarm in addition to the data of the servomotor A. For example, the information-upon-alarm-occurrence listing data 82 may include data B₁₃, B₂₃, B₃₃, B₄₃, C₁₃, and C₂₃ in addition to data A₁₃, A₂₃, and A₃₃. By obtaining data also from the servomotors B and C other than the servomotor A in which the alarm has occurred, data of the servomotors B and C in which no alarm has occurred can also be displayed in the information-upon-alarm-occurrence list screen.

Similarly, if data of the servo amplifier 10₂ is to be displayed, the drive recorder information listing data includes data D₃₄. Alternatively, if data of the servo amplifier 10₃ is to be displayed, the drive recorder information listing data includes data G₂₅. Note that an upper limit of the storage capacity of the servo amplifier 10 causes the drive recorder information listing data 83 to no longer include data that has been overwritten and deleted. For example, if the drive recorder information of data A₂₃ has been overwritten with the drive recorder information of data B₂₅, which has been then stored, data A₂₃ is no longer included in the drive recorder information listing data 83.

When data of the servo amplifier 10₁ is to be displayed, specifying data A₂₃ to display a graphical waveform causes the programmable display device 30 to obtain the graphical waveform data 81 including data A₂₁, A₂₂, A₂₃, A₂₄, and A₂₅ from the servo amplifier 10₁, and causes the display unit 309 to display the graphical waveform display screen 50. In addition, specifying data A₂₃ to display the information-upon-alarm-occurrence list causes the programmable display device 30 to obtain the information-upon-alarm-occurrence listing data 82 including data A₁₃, A₂₃, A₃₃, B₁₃, B₂₃, B₃₃, B₄₃, C₁₃, and C₂₃ from the servo amplifier 10₁, and causes the display unit 309 to display the information-upon-alarm-occurrence list screen 60.

The graphical user interface processing unit 305 further has a function to set, to the servo amplifiers 10, the types of alarm of the drive recorder information to be held. Thus, the programmable display device 30 can set, to a servo amplifier 10, the types of alarm of the drive recorder information to be held by that servo amplifier 10. In this case, the detail of the parameter change that is input through the input unit 310 is transferred by the operational input processing unit 308 to the graphical user interface processing unit 305. The graphical user interface processing unit 305 then sends the information to be written into the servo amplifier 10 to the control unit 301 based on the detail received. The control unit 301 examines the information sent from the graphical user interface processing unit 305, determines that the information needs to be transferred to the communication processing unit 307, and thus sends the information to the communication processing unit 307. The communication processing unit 307 performs a write operation to the servo amplifier 10 based on the information received from the control unit 301. Thus, writing a parameter from the programmable display device 30 into the servo amplifier 10 enables the number of items of the data held in the servo amplifier 10 by the drive recorder function to be reduced.

Collection of data required for alarm analysis of a servo amplifier usually requires a sampling period shorter than the sampling period of the programmable display device to obtain data from the device to be analyzed. This conventionally requires storing the data required for alarm analysis in a memory of the servo amplifier to thereafter collect the data by connecting a personal computer to the servo amplifier. In contrast, the programmable display device 30 according to the first embodiment can collect data held in the servo amplifier 10 on the programmable display device 30 by being connecting to the servo amplifier 10, and can display the data in the form of a graph or table. This enables alarm analysis to be performed even if no personal computer is available. Thus, the FA system 100 can he restored in a short time even at a site where there is a limitation on availability of a personal computer.

The programmable display device 30 can also display the status of the programmable logic controller 20 that constitutes a part of the FA system 100. Thus, displaying of the status display screen for the programmable logic controller 20 and the drive recorder information list screen 40, the information-upon-alarm-occurrence list screen 60, or the graphical waveform display screen 50 for the servo amplifier 10 in an overlapping manner further facilitates the alarm analysis process. Note that installing a dedicated software tool for the programmable logic controller 20 and a dedicated software tool for the servo amplifier 10 in a personal computer, and running these software tools at the same time can theoretically display both the status display screen for the programmable logic controller 20 and the drive recorder information list screen 40, the information-upon-alarm-occurrence list screen 60, or the graphical waveform display screen 50 for the servo amplifier 10 in an overlapping manner. However, running these dedicated software tools at the same time results in an increase in processing load of the personal computer. Thus, although use of a high performance personal computer can display both the status display screen for the programmable logic controller 20 and the drive recorder information list screen 40, the information-upon-alarm-occurrence list screen 60, or the graphical waveform display screen 50 of the servo amplifier 10 in an overlapping manner, a personal computer available at site may often have only insufficient processing performance.

The foregoing description has described the process in which the drive recorder information presentation function is invoked when the user performs the first operational option, the second operational option, or the third operational option. However, the graphical user interface processing unit 305 may invoke the drive recorder information presentation function in conjunction with the occurrence of an alarm in the servo amplifier 10 to obtain the drive recorder information listing data, the graphical waveform data, and the information-upon-alarm-occurrence listing data from the servo amplifier 10, and store these data in the file storage unit 303 or in the storage medium connected to the storage medium input-output unit 304 as a file having a user-specified format. Specifically, the graphical user interface processing unit 305 may monitor the servo amplifier 10 for any change in a device condition of the servo amplifier 10, and if a change in a device condition is detected, invoke the drive recorder information presentation function to obtain the drive recorder information listing data, the graphical waveform data, and the information-upon-alarm-occurrence listing data from the servo amplifier 10, and store the drive recorder information listing data, the graphical waveform data, and the information-upon-alarm-occurrence listing data in the file storage unit 303 or in the storage medium connected to the storage medium input-output unit 304.

Such configuration enables the programmable display device 30 according to the first embodiment to monitor the servo amplifier 10 for a change in the state of an alarm, and if a change occurs, automatically obtain the drive recorder information, thus to obtain the drive recorder information listing data, the graphical waveform data, and the information-upon-alarm-occurrence listing data from the servo amplifier 10 in conjunction with the occurrence of an alarm. If a personal computer having a dedicated software tool installed is used, the device memory of the programmable logic controller 20 is consulted upon the occurrence of an alarm, the change in the state of the alarm cannot be detected. Accordingly, use of a personal computer having a dedicated software tool installed makes it difficult to automatically obtain the drive recorder information listing data, the graphical waveform data, and the information-upon-alarm-occurrence listing data from the servo amplifier 10 when a change in the state of the alarm is detected.

An upper limit of the amount of data that can be held in the servo amplifier 10 with respect to the drive recorder function causes the servo amplifier 10 to overwrite older data with newer data. Therefore, when the drive recorder information presentation function is invoked by a user operation, data at the time of the occurrence of the alarm may be overwritten with another data, and may thus no longer exist in the servo amplifier 10 when the drive recorder information presentation function is invoked. Although an increase in the memory capacity of the servo amplifier 10 will lower the possibility of overwriting of the data at the time of the occurrence of the alarm with another data, manufacturing cost of the servo amplifier 10 will increase. The invocation of the drive recorder information presentation function in conjunction with the occurrence of an alarm in the servo amplifier 10 allows the programmable display device 30 to obtain the graphical waveform data and the information-upon-alarm-occurrence listing data from the servo amplifier 10 before the data upon the occurrence of the alarm is overwritten with another data. This operation can prevent the situation in which the cause of the occurrence of the alarm cannot be clarified. Note that the storage medium connected to the storage medium input-output unit 304 of the programmable display device 30 typically has a storage capacity greater than the storage capacity of the memory of the servo amplifier 10, and it is thus unlikely that the data obtained from the servo amplifier 10 fails to be stored in the storage medium due to an insufficient remaining storage capacity of the storage medium connected to the storage medium input-output unit 304.

### Second Embodiment

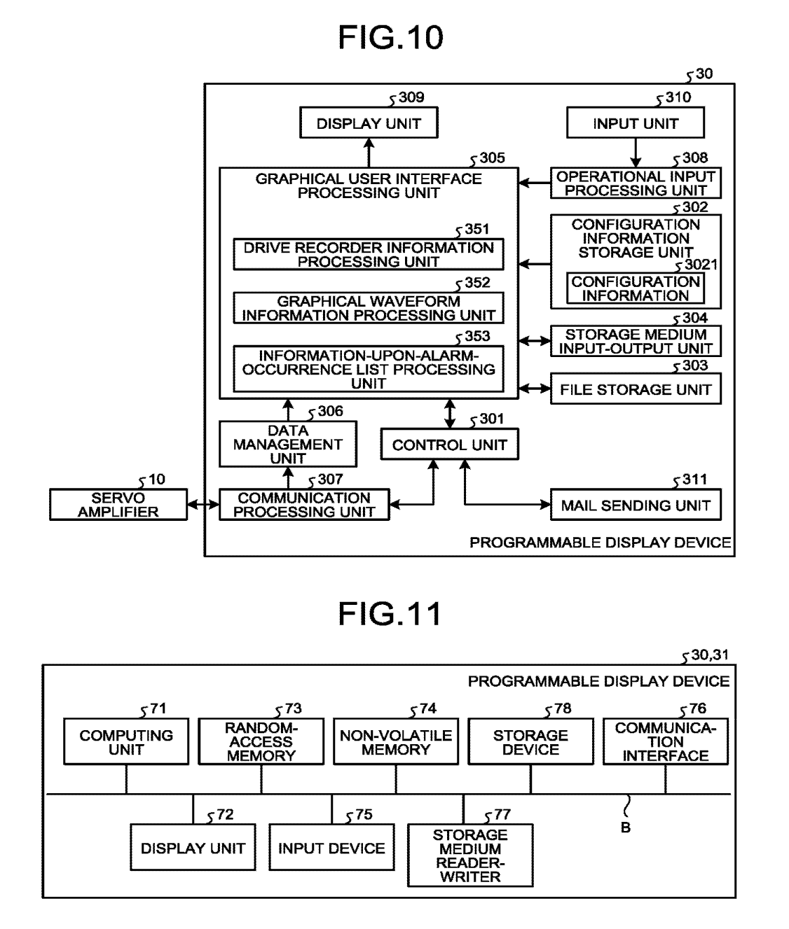

FIG. 10 is a functional block diagram of a programmable display device according to a second embodiment of the present invention. A programmable display device 31 according to the second embodiment differs from the programmable display device 30 according to the first embodiment in including a mail sending unit 311 that sends an electronic mail (hereinafter referred to as “email”). The mail sending unit 311 has a function to send an email using Simple Mail Transfer Protocol (SMTP).

In the programmable display device 31 according to the second embodiment, the graphical user interface processing unit 305 can send at least one of the drive recorder information listing data, the graphical waveform data, and the information-upon-alarm-occurrence listing data obtained from the servo amplifier 10 as an attachment of an email to a personal computer at another location. For example, use of a button for sending an email in the drive recorder information list screen 40, in the graphical waveform display screen 50, or in the information-upon-alarm-occurrence list screen 60 enables the user to perform a user operation to send the drive recorder information listing data, the graphical waveform data, or the information-upon-alarm-occurrence listing data as an attachment of an email. This enables the FA system 100 to be restored in a short time at a site where there is a limitation on availability of a personal computer.

The programmable display device 31 according to the second embodiment may send the drive recorder information listing data, the graphical waveform data, or the information-upon-alarm-occurrence listing data as an attachment of an email in conjunction with the occurrence of an alarm of the servo amplifier 10. That is, the graphical user interface processing unit 305 may monitor the servo amplifier 10 for a change in the state of an alarm, and if a change in the state of the alarm is detected in the servo amplifier 10, obtain the drive recorder information from the servo amplifier 10, and send an email to a pre-registered destination. Obtaining the drive recorder information from the servo amplifier 10 in conjunction with a change in the state of an alarm, and sending an email to a pre-registered destination enables the drive recorder information to be held in the personal computer at the destination of the email even if the data obtained from the servo amplifier 10 fails to be stored in the storage medium connected to the storage medium input-output unit 304 due to an insufficient remaining storage capacity of the storage medium.

The hardware configuration of the programmable display device 30 according to the first embodiment and of the programmable display device 31 according to the second embodiment will next be described. FIG. 11 is a diagram illustrating a hardware configuration of the programmable display devices according to the first and second embodiments. The programmable display devices 30 and 31 each include a computing unit 71, a display unit 72, a random-access memory 73, a non-volatile memory 74, an input device 75, a communication interface 76, a storage medium reader-writer 77, and a storage device 78. The computing unit 71, the display unit 72, the random-access memory 73, the non-volatile memory 74, the input device 75, the communication interface 76, the storage medium reader-writer 77, and the storage device 78 are connected to one another via a bus B.

The functions of the graphical user interface processing unit 305, the operational input processing unit 308, the control unit 301, and the mail sending unit 311 are provided by the computing unit 71 executing one or more programs stored in the non-volatile memory 74 or in the storage device 78 using the random-access memory 73 as a work area. The one or more programs are implemented in software, firmware, or a combination of software and firmware. The functions of the configuration information storage unit 302 and the file storage unit 303 are provided by the non-volatile memory 74 or the storage device 78. The functions of the data management unit 306 are provided by the random-access memory 73. The functions of the communication processing unit 307 are provided by the communication interface 76. The functions of the storage medium input-output unit 304 are provided by the storage medium reader-writer 77. The functions of the display unit 309 are provided by the display unit 72. The display unit 72 may be a liquid crystal display unit or an organic electroluminescence display unit. The functions of the input unit 310 are provided by the input device 75. The computing unit is a processor such as a central processing unit (CPU). The input device 75 is a touch panel. The storage device 78 may be a hard disk drive or a solid state drive.

The configurations described in the foregoing embodiments are merely examples of various aspects of the present invention. These configurations may be combined with a known other technology, and moreover, a part of such configurations may be omitted and/or modified without departing from the spirit of the present invention.

### REFERENCE SIGNS LIST

10, 10₁, 10₂, 10₃ servo amplifier; 20 programmable logic controller; 21, 22, 23, 24 programmable logic controller unit; 30, 31 programmable display device; 40 drive recorder information list screen; 41 alarm number; 42 alarm name; 43 occurrence time; 44 waveform display button; 45 information-upon-alarm-occurrence list display button; 46, 53, 61 save button; 47 save all button; 48, 54, 62 open button; 50 graphical waveform display screen; 51 waveform display region; 52 vertical axis display region; 55, 63 screen transition switch; 60 information-upon-alarm-occurrence list screen; 71 computing unit; 72 display unit; 73 random-access memory; 74 non-volatile memory; 75 input device; 76 communication interface; 77 storage medium reader-writer; 78 storage device; 81 graphical waveform data; 82 information-upon-alarm-occurrence listing data; 100 FA system; 301 control unit; 302 configuration information storage unit; 303 file storage unit; 304 storage medium input-output unit; 305 graphical user interface processing unit; 306 data management unit; 307 communication processing unit; 309 operational input processing unit; 309 display unit; 310 input unit; 311 mail sending unit; 351 drive recorder information processing unit; 352 graphical waveform information processing unit; 353 information-upon-alarm-occurrence list processing unit; 3021 configuration information; B bus.

1. A programmable indicator comprising:
a drive recorder information processor to obtain a specific set of data from a servo amplifier that holds drive recorder information including both a first set of data, being a plurality of items of data relating to a servomotor in which an alarm has occurred, and also being sequential data of before and after the occurrence of the alarm, and a second set of data, being data of all the items upon the occurrence of the alarm in the servomotor in which the alarm has occurred, the specific set of data being a third set of data indicating the alarm corresponding to the drive recorder information held in the servo amplifier, and to display a first screen that displays a list of the alarms whose drive recorder information is held in the servo amplifier; and
a graphical waveform information processor to obtain the first set of data from the servo amplifier, and to display a second screen that displays a graphical representation of the first set of data.

2. The programmable indicator according to claim 1, comprising:
an information-upon-alarm-occurrence list processor to obtain the second set of data from the servo amplifier, and to display a third screen that displays a list of data included in the second set of data.

3. A programmable indicator comprising:
a drive recorder information processor to obtain a specific set of data from a servo amplifier that holds drive recorder information including both a first set of data, being a plurality of items of data relating to a servomotor in which an alarm has occurred, and also being sequential data of before and after the occurrence of the alarm, and a second set of data, being data of all the items upon the occurrence of the alarm in the servomotor in which the alarm has occurred, the specific set of data being a third set of data indicating the alarm corresponding to the drive recorder information held in the servo amplifier, and to display a first screen that displays a list of the alarms whose drive recorder information is held in the servo amplifier; and
an information-upon-alarm-occurrence list processor to obtain the second set of data from the servo amplifier, and to display a third screen that displays a list of data included in the second set of data.

4. The programmable indicator according to claim 1, wherein a type of the alarm of the drive recorder information to be held is set to the servo amplifier.

5. The programmable indicator according to claim 1, wherein the first set of data, the second set of data, and the third set of data obtained from the servo amplifier are sent to a pre-registered destination using an electronic mail.

6. The programmable indicator according to claim 5, wherein the programmable indicator monitors the servo amplifier for a change in a state of the alarm, and if a change in the state of the alarm of the servo amplifier is detected, the programmable indicator obtains the drive recorder information from the servo amplifier, and sends the drive recorder information to the pre-registered destination using an electronic mail.

7. The programmable indicator according to claim 6, wherein the programmable indicator stores the first set of data, the second set of data, and the third set of data obtained from the servo amplifier in a storage medium as a file having a previously specified format.

8. The programmable indicator according to claim 7, wherein the programmable indicator monitors the servo amplifier for a change in the state of the alarm, and if a change in the state of the alarm of the servo amplifier is detected, the programmable indicator obtains the drive recorder information from the servo amplifier, and stores the first set of data, the second set of data, and the third set of data in the storage medium as a file having the previously specified format.

9. The programmable indicator according to claim 1, wherein the programmable indicator stores the first set of data, the second set of data, and the third set of data obtained from the servo amplifier in a storage medium as a file having a previously specified format.

10. The programmable indicator according to claim 9, wherein the programmable indicator monitors the servo amplifier for a change in a state of the alarm, and if a change in the state of the alarm of the servo amplifier is detected, the programmable indicator obtains the drive recorder information from the servo amplifier, and stores the first set of data, the second set of data, and the third set of data in the storage medium as a file having the previously specified format.

11. The programmable indicator according to claim 3, wherein the first set of data, the second set of data, and the third set of data obtained from the servo amplifier are sent to a pre-registered destination using an electronic mail.

12. The programmable indicator according to claim 11, wherein the programmable indicator monitors the servo amplifier for a change in a state of the alarm, and if a change in the state of the alarm of the servo amplifier is detected, the programmable indicator obtains the drive recorder information from the servo amplifier, and sends the drive recorder information to the pre-registered destination using an electronic mail.

13. The programmable indicator according to claim 12, wherein the programmable indicator stores the first set of data, the second set of data, and the third set of data obtained from the servo amplifier in a storage medium as a file having a previously specified format.

14. The programmable indicator according to claim 13, wherein the programmable indicator monitors the servo amplifier for a change in the state of the alarm, and if a change in the state of the alarm of the servo amplifier is detected, the programmable indicator obtains the drive recorder information from the servo amplifier, and stores the first set of data, the second set of data, and the third set of data in the storage medium as a file having the previously specified format.

15. The programmable indicator according to claim 3, wherein the programmable indicator stores the first set of data, the second set of data, and the third set of data obtained from the servo amplifier in a storage medium as a file having a previously specified format.

16. The programmable indicator according to claim 15, wherein the programmable indicator monitors the servo amplifier for a change in a state of the alarm, and if a change in the state of the alarm of the servo amplifier is detected, the programmable indicator obtains the drive recorder information from the servo amplifier, and stores the first set of data, the second set of data, and the third set of data in the storage medium as a file having the previously specified format.
